(19) United States
(12) Patent Application Publication
(10) Pub. No.: US 2025/0285076 A1
(43) Pub. Date: Sep. 11, 2025

(54) System and Method for Predictive Supply Chain Management

(71) Applicant: LIFE TECHNOLOGIES CORPORATION, Carlsbad, CA (US)

(72) Inventor: Chase Hooks Skjolsvik, Carlsbad, CA (US)

(21) Appl. No.: 19/073,958

(22) Filed: Mar. 7, 2025

Related U.S. Application Data
(60) Provisional application No. 63/562,587, filed on Mar. 7, 2024.

(51) Int. Cl. G06Q 10/087; G06Q 10/0635; G06Q 10/0875; G06Q 30/0202

(52) U.S. Cl. CPC G06Q 10/087; G06Q 10/0635; G06Q 10/0875; G06Q 30/0202

(57) ABSTRACT

Various embodiments of the present invention comprise a supply chain platform configured in connection with an inventory hub, a supplier system, an enterprise data platform, and a customer system to respond to disturbance events within a supply chain. Such a supply chain platform may collect a variety of supply chain data to determine a risk score relating to such disturbance event(s) and one or more mitigation opportunities in response thereto via a mitigation module configured to generate one or more scenarios and assess the same for efficacy and readiness. Such mitigation opportunities may include the use of one or more supplier sites within the supply chain. Such a supply chain platform may be configured to generate a plurality of reports having interactive data visualizations configurable according to key element data and/or parameter input(s) supplied by a user through a user device and may differentiate between important and inconsequential disturbance events.

### CROSS-REFERENCE TO RELATED APPLICATIONS

The present Non-Provisional application claims priority to the earlier-filed and currently Provisional Application No. 63/562,587 having a filing date of Mar. 7, 2024, the contents of which are hereby incorporated by reference in its entirety.

### BACKGROUND

Supply chain management, namely the management of the flow of goods and services which transform raw materials into finished products for consumers, is equally as important and it is complex. Failure to adequately manage a supply chain may result in significant delays, increase operating and/or production costs, and potentially jeopardize client relationships. And while the complexity of supply chains may derive from a business itself, complexity often arises from unforeseen and uncontrollable external factors. Indeed, business-related disruptions—e.g., factory disruptions, labor disruptions, sales disruptions, supplier disruptions, mergers and acquisitions, and legal actions—are only one piece of the puzzle as pandemics, wars, famines, and natural disasters similarly serve to disrupt supply chains. Any one of the foregoing disruptions may quickly and easily work its way through a supply chain as a delay in one supply chain node may impact the timeliness of work at another node. Consequently, adequate management of a supply chain is imperative for many, if not all businesses. And adequate management of a supply chain mandates quick, decisive, and accurate decision making in response to the myriad threats which may negatively effect production and delivery.

For certain organizations, the complexity of supply chain management increases as a result of the size and nature of the business. Efforts to reduce complexity, and thereby improve response time, production time, and resource efficiency, for many large organizations often involves supply chain integration through which an organization attempts to bring various links within a supply chain closer together. In so doing, integration aims to increase the sharing of information between the supply chain links and/or nodes, more efficiently allocate costs, and reduce response times to any issues that may arise.

Vertical integration is one such way a company may seek to better integrate the various parts of its business. Through vertical integration, a company seeks to control multiple stages of its production process, whether by taking greater control over its suppliers and/or by taking greater control over its distributors. While vertical integration may be effective at reducing costs, improving efficiency, and offering a company greater control over its supply chain, such vertically integrated organizations often run into difficulties with supply chain management. For instance, vertical integration requires much upfront investment and thus increases risk. Further, because vertically integrated organizations control larger portions if not the entirety of their supply chain, such organizations are often cumbersome and inflexible. As a result, vertically integrated organizations often respond slowly to changes, both in the market and to disruptions in their supply chain. Without third-party suppliers and/or distributors to easily turn to, any such issues can often infect the entirety of the business in the absence of adequate planning.

Such difficulties are often exacerbated for organizations having disparate business groups utilizing disparate technological solutions, or where the flow of information is often stilted. For instance, different businesses within the organization may use different enterprise resource planning systems, such as when the organization services a vast and varied customer base mandating different approaches to resource planning. Similarly, disjointed communication channels and obstructive approval processes may stem the flow of information and disrupt prompt decision making. As a result, such vertically integrated organizations often produce labored responses in the face of a disruptive event, which naturally wastes resources, whether by producing unnecessary stock of a given product or failing to timely source a replacement component according to the needs of its customers. Hence, forecasting risk and enabling swift, responsive action is imperative to avoid delays and disruptions in the supply chains of vertically integrated organizations.

Conventional supply chain management systems aim to resolve some of these issues via forecasting tools and real-time data management to facilitate decision making. Such conventional systems typically focus on logistics, purchasing, and enterprise resource planning, with the goal of automating ways to manage a supply chain network. However, such conventional systems are often insufficient for the type of vertically integrated organizations discussed heretofore, as their one-size-fits-all approach fails to account for the unique needs of such organizations. For instance, such conventional systems often fail to account for issues relating to the flow of information and fail to appreciate the inflexible nature of such organizations. Similarly, such conventional systems commonly over-signal potential issues, lest they miss something important. Yet, this inundation of data often means key issues are overlooked or dismissed, whereas nominal issues are readily resolved. The end result is a system often lacking sufficient insight and solutions, and one which distracts users from the important issues.

In view thereof, there exists a need in the art for a supply chain management system configured to increase the efficiency and adaptability of supply chains operated by vertically integrated organizations. Such a system should be configured to provide greater visibility across an organization, provide predictive analyses, and develop prescriptive plans in response to a disruptive event. Furthermore, such a system should be configured to provide insights between various segments of the organization and harmonize designs and strategies to facilitate site-to-site sharing. Such a system should further be user-configurable to enable specific parameterization of the analyses of outputs thereof. Additionally, such a system should be configured to quickly and accurately identify the important from the mundane, thereby enabling users to quickly address key issues.

### BRIEF SUMMARY

Various embodiments of the present invention are directed to a supply chain management system configured to resolve one or more of the aforementioned needs in the art, such as increasing visibility and adaptability in response to supply chain disturbances across vertically integrated supply chains and differentiating between important and inconsequential supply chain disruption events.

For instance, in at least one embodiment of the present invention, such a supply chain management system may comprise: an inventory management hub communicatively configured in connection with a supply chain platform; said supply chain platform communicatively configured in connection with at least one customer system and at least one user device; said supply chain platform comprising a supply chain server system configured to perform at least one process of said supply chain platform; said supply chain platform further comprising: a data receipt module configured to receive said supply chain data from said inventory management hub; an analytics system configured to determine at least one risk score according to a risk calculation routine performed on said supply chain data; said analytics system further configured to generate at least one mitigation opportunity according to a mitigation module; and a report module configured to generate at least one interactive data visualization for display on said at least one user device, said at least one interactive data visualization based on said at least one risk score and said at least one mitigation opportunity.

In at least one alternative embodiment of the present invention, such a supply chain management system may comprise: an inventory management hub communicatively configured in connection with a supply chain platform; said supply chain platform communicatively configured in connection with at least one customer system and at least one user device; said supply chain platform comprising a supply chain server system configured to perform at least one process of said supply chain platform; said supply chain platform further comprising: a data receipt module configured to receive said supply chain data from said inventory management hub; a historical data module configured to generate historical data; an analytics system comprising a risk and recovery module configured to determine at least one risk score according to a risk calculation routine performed on said supply chain data and said historical data; said analytics system further comprising a mitigation module configured to generate at least one mitigation opportunity according to said supply chain data and said historical data; and a report module configured to generate at least one interactive data visualization for display on said at least one user device, said at least one interactive data visualization based on said at least one risk score and said at least one mitigation opportunity.

In yet additional embodiments of the present invention, such a supply chain management system may comprise: an inventory management hub communicatively configured in connection with a supply chain platform and a supplier system, said supplier system comprising a primary supplier site and at least one secondary supplier site, said primary supplier site having constraint data indicating a potential disturbance; said supply chain platform communicatively configured in connection with at least one customer system and at least one user device; said supply chain platform comprising a supply chain server system configured to perform at least one process of said supply chain platform; said supply chain platform further comprising: a data receipt module configured to receive said supply chain data from said inventory management hub and said constraint data from said primary supplier site; a historical data module configured to generate historical data; a dashboard module comprising a key element component configured to receive key element data from said at least one user device and a parameter component configured to receive at least one parameter input from said at least one user device; an analytics system comprising a risk and recovery module configured to determine, in response to said constraint data, at least one risk score and at least one risk classification according to a risk calculation routine performed on said supply chain data and said historical data; said analytics system further comprising a mitigation module configured to generate at least one mitigation opportunity, said at least one mitigation opportunity generated according to a scenario module configured to determine at least one scenario dataset and a scenario efficacy module configured to determine an efficacy metric and a deployment metric for said at least one scenario dataset; and a report module configured to generate at least one interactive data visualization for display on said at least one user device, said at least one interactive data visualization based on said at least one risk score and said at least one mitigation opportunity, and configurable according to said at least one parameter input. As may be understood, the foregoing embodiments are merely exemplary.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a block diagram of a supply chain platform in accordance with at least one embodiment of the present invention.

FIG. 1B illustrates a block diagram of a communicative configuration between a supplier system, an inventory management database, an enterprise data platform, a customer system, an administrator system, and a supply chain platform, in accordance with at least one embodiment of the present invention, such as the one depicted in FIG. 1A.

FIG. 1C illustrates a block diagram of a user device which may be used in connection with the various systems, databases, and platforms shown in the embodiments depicted in FIG. 1A and FIG. 1B.

FIG. 2 illustrates a block diagram of the supply chain of an organization, in accordance with at least one embodiment of the present invention.

FIG. 3A illustrates a block diagram of a supply chain platform, in accordance with at least one embodiment of the present invention.

FIG. 3B illustrates a block diagram of a data receipt module, in accordance with the embodiment depicted in FIG. 3A.

FIG. 3C illustrates a block diagram of an analytics system, and the risk and recovery module and inventory entitlement module thereof, in accordance with the embodiment depicted in FIG. 3A.

FIG. 3D illustrates a block diagram of one embodiment of a mitigation module, in accordance with the embodiments depicted in FIGS. 3A-3C.

FIG. 3E illustrates a block diagram of one alternative embodiment of a mitigation module, in accordance with the embodiments depicted in FIGS. 3A-3C.

FIG. 4A illustrates an output of the glidepath module, in accordance with at least one embodiment of the present invention.

FIG. 4B illustrates an output of the material risk module, in accordance, in accordance with at least one embodiment of the present invention.

FIG. 4C illustrates a user interface representation of an aspect of the subject matter in accordance with one embodiment.

FIG. 4D illustrates an output of an interactive data visualization, in accordance with at least one embodiment of the present invention.

FIG. 4E illustrates an output of a material risk module, in accordance with at least one embodiment of the present invention.

FIG. 4F illustrates an output of a shipping status module, in accordance with at least one embodiment of the present invention.

FIG. 4G illustrates an output of a quarterly status module, in accordance with at least one embodiment of the present invention.

FIG. 4H illustrates an output of a surplus status module, in accordance with at least one embodiment of the present invention.

FIG. 4I illustrates an output of an expiration status module, in accordance with at least one embodiment of the present invention.

FIG. 4J illustrates an output of a portfolio module, in accordance with at least one embodiment of the present invention.

FIG. 4K illustrates an output of a portfolio module, in accordance with at least one embodiment of the present invention.

### DETAILED DESCRIPTION

Various embodiments of the present disclosure are directed to a supply chain system 100 generally configured to provide end-to-end response and mitigation strategies to supply chain disturbances, such as those resulting in material constraints, as well as provide numerous reports and tools through which a user may both investigate and tailor a supply chain response to the particular situation at-hand. In at least some embodiments, the supply chain system 100 of the present disclosure may include a supply chain platform 302 configured to determine a risk associated with a disturbance event, appropriately tailor inventory entitlement to limit excess inventory, and utilize scenarios to develop and suggest mitigation strategies to such disturbance event. Even further, various embodiments of such a supply chain platform 302 may include a variety of reports and other interactive data visualization(s) 404 through which a user may identify risks and the components thereof, how these risks may impact a customer, and how a given mitigation strategy may affect both the customer at issue, as well as the organization at large. And finally, various embodiments of such a supply chain platform 302 may be configured to identify, signal, or otherwise differentiate between key events and exceptions—i.e., those events offering only minimal threat of a supply chain distribution.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

The description may use phrases such as “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of values, the phrase “between X and Y” represents a range that includes X and Y. As used herein, an “apparatus” may refer to any individual device, collection of devices, part of a device, or collections of parts of devices. The drawings are not necessarily to scale.

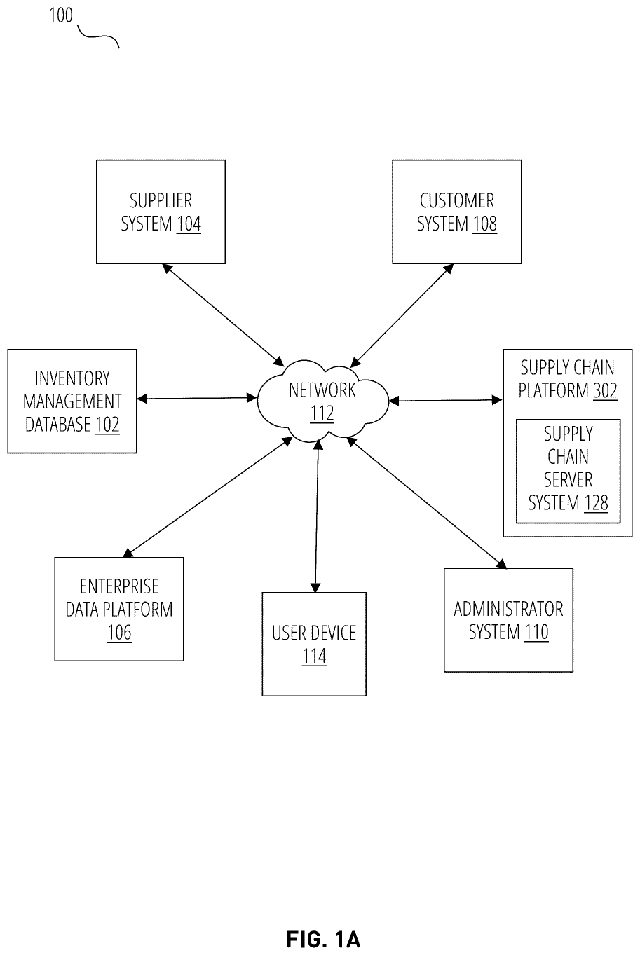

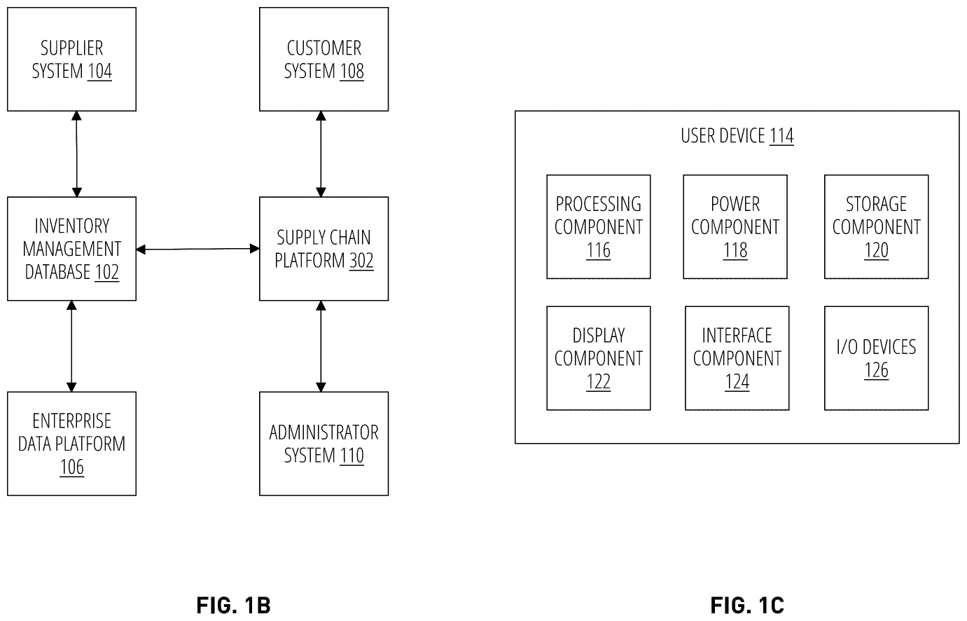

Depicted in FIG. 1A is an exemplary embodiment of a supply chain system 100 in accordance with the present disclosure. Specifically, the supply chain system 100 of various embodiment of the present disclosure may include a supply chain platform 302 communicatively configured in connection with a variety of systems, databases, and platforms for the collection and transmission of relevant data through at least one network 112, such as the internet, an intranet and/or wireless network, a wireless local area network, a metropolitan area network, and/or some other wireless network akin thereto. Further, it may be understood each such system and/or platform may be operable by a user(s) through user device(s) 114 configured to communicate over such network 112.

For instance, such a supply chain platform 302 may be communicatively coupled with: (a) an inventory management database 102, which may be configured to store, at least in part, inventory-related data from a plurality of manufacturing sites, shipping sites, and other related nodes along a supply chain; (b) an enterprise data platform 106, which may comprise one or more systems storing and/or transmitting data relating to the organization owning, running, presiding over, or otherwise operating the supply chain platform 302; (c) a supplier system 104, which may comprise the various systems of one or more entities configured to supply the resulting supply chain with raw materials, products, or other goods related to a purchase order from a customer; (d) a customer system 108, which may comprise one or more systems configured to store and/or transmit data relating to a given customer, such as the party placing a purchase order with the organization; and (e) an administrator system 110, which may comprise a system configured to store and/or transmit data relating to an administrator of the supply chain platform 302, such as an employee and/or individual of the organization operating the supply chain platform 302. As may be understood, the foregoing systems and/or platforms may be distributed over multiple databases and/or systems, including one or more servers. Each of these systems, platforms, and databases will be discussed in greater detail hereafter.

With continued reference to FIG. 1A and further reference to FIG. 1B, it may be seen at least one embodiment of the present disclosure may be configured such that certain systems, databases, and platforms are communicatively isolated and/or distinct from each other. For instance, in the embodiment depicted in FIG. 1B, the supplier system 104 and enterprise data platform 106 are each solely communicatively coupled with the inventory management database 102, which may thus be configured to collect and aggregate the relevant data flowing therefrom. Likewise, the customer system 108 and the administrator system 110 may each be solely communicatively coupled with the supply chain platform 302. As a result, each such entity—e.g., customer, supplier, and administrator—may communicate with the supply chain platform 302 while maintaining at least some degree of blinding and/or confidentiality as to the other's data. Finally, the inventory management database 102 and the supply chain platform 302 may be communicatively coupled together, thereby enabling the supply chain platform 302 full access to the relevant data from the supplier system 104 and enterprise data platform 106. As may be understood, alternative arrangements of communicative coupling between the various systems, databases, platforms, and/or user device(s) 114 of the present disclosure are envisioned herein.

In at least one embodiment, such as that depicted in FIG. 1A, such a supply chain platform 302 may generally comprise a supply chain server system 128, which may itself comprise some computer-related structure and/or entity configured to perform one or more specific functionalities, whether based in hardware, software, or some combination thereof. For example, such a supply chain platform 302 may be configured as a process running on a processor, a processor itself, a hard disk drive, a plurality of storage drives, an object, an executable, a computer-executable program, and/or a computer. In at least one embodiment, such a supply chain platform 302 may be configured to operate using and/or in connection with a relational database management system and/or a cloud database such as Microsoft Azure SQL. Alternatively, such a supply chain platform 302 may instead be configured to operate using and/or in connection with the enterprise data platform 106 itself, such as via backend development configured thereon. Likewise, such a supply chain platform 302 may itself generally comprise a platform-as-a-service (Paas) and/or an application-platform-as-a-service (aPaaS). As may be understood, alternative such modes of configuration for such supply chain server system 128 are envisioned herein.

Likewise, the various systems and/or platforms communicatively configured in connection with the supply chain platform 302 may similarly comprise some computer-related entity configured to perform one or more specific functionalities, whether based in hardware, software, or some combination thereof. For example, the enterprise data platform 106 may be configured to operate using one or more cloud-based computing platforms, such as Amazon Web Services. The various systems of the supplier system 104, customer system 108, and/or administrator system 110, meanwhile may each function according to their own computing preferences. Accordingly, it may be understood such systems and platforms should be construed as non-limiting according to their computing platforms and structures, as may be understood by those skilled in the art.

FIG. 1C depicts at least one embodiment of a user device 114, through which a user may interact with the supply chain platform 302 and/or any other interconnected systems and/or platforms. Such a user device 114 may comprise, for instance, a smart phone, laptop, computer, tablet, or other similar device, and may include a plurality of electrical and electronic components configured to provide power, operational control, and/or protection to the same. For instance, such a user device 114 may comprise a processing component 116, such as an electronic microprocessor, microcontroller, or other similar device, a power component 118, such as a battery, and a storage component 120, such as a memory, including, without limitation, a non-transitory, computer-readable memory. Likewise, such a user device 114 may additionally comprise a display component 122, such as a screen or touchscreen, and an interface component 124, which may be configured to receive data and provide data to the user, such as in audible, textual, and/or graphical form. Finally, such a user device 114 may additionally comprise I/O devices 126, such as a touchscreen, keypad, keyboard, cursor-controlled device, or other similar component configured to provide input-output functionality.

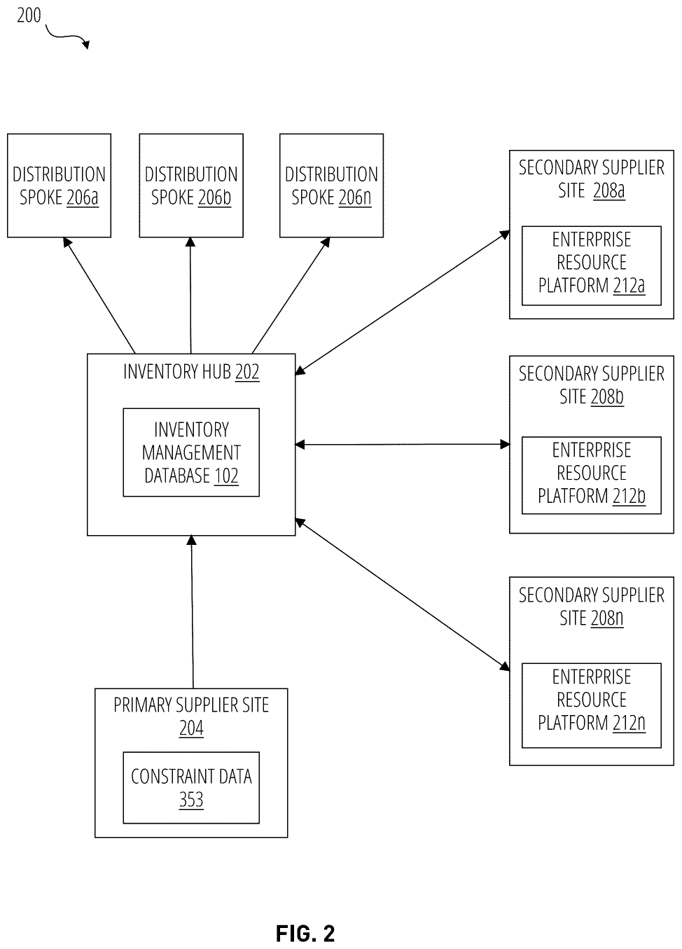

FIG. 2 depicts at least one embodiment a logistical structure 200—i.e., a supply chain and/or organizational structure—for a given organization. In at least one embodiment, such a logistical structure 200 may be owned and/or operated by, for instance, the entity owning, running, and/or operating the supply chain platform 302. Shown in the embodiment depicted in FIG. 2 is an exemplary logistical structure 200 for an organization having a vertically-integrated structure—i.e., a logistical structure 200 wherein the organization controls multiple stages of the production process and, thereby the supply chain itself, as discussed in greater detail heretofore. As may be understood, the depicted embodiment is merely exemplary and simplified for the sake of brevity. Notwithstanding, it may be understood constraint data 353 emanating from a primary supplier site 204 may flow through an inventory hub 202 having an inventory management database 102 operating therefrom and ultimately affect at least one distribution spoke(s) 206a-206n. Such distribution spokes 206a-206n may comprise one or more distribution centers and/or other entities, locations, and/or facilities associated with the logistical structure 200 of the organization, whether or not ostensibly configured to fulfill a particular order from a customer in relation to the primary supplier site 204. As may be understood, the logistical structure 200 of various embodiments contemplated herein may include a plurality of primary supplier sites 204, each interconnected with a number of distribution spokes 206a-206n and, as discussed hereafter, secondary supplier sites 208a-208n.

In view of the foregoing, it may be understood such constraint data 353 may comprise some data relating to a constraint which may and/or will affect the supply chain of an organization, such as an insufficient amount of raw material to generate a part. As may be understood, such constraint data 353 may result from any given supply chain disturbance, whether external in nature—e.g., war, famine, pandemic, regulatory, etc.—or internal in nature—e.g., personnel, site defects, breakage in manufacturing line, etc. Hence, it may be understood such constraint data 353 may include all information pertinent to the relevant complaint, such as, without limitation, the part number at issue, the projected deficit, the expected downtime, the customer order(s) impacted, etc.

With continued reference to FIG. 2, it may be seen such an inventory hub 202 may further be interconnected with one or more secondary supplier sites 208a-208n. Each such secondary supplier site 208a-208n may comprise a location, such as a manufacturing location or a distribution center, which may be configured to respond to the constraint data 353 restricting the operations of the primary supplier site 204. As may be noted, each such secondary supplier site 208a-208n may comprise its own enterprise resource platform 212a-212n, which may, in at least some embodiments, be distinct from any similar system and/or platform utilized by or otherwise communicating with the inventory management database 102 of the inventory hub 202. With reference to FIG. 1B, it should be understood such primary supplier site 204, distribution spokes 206a-206n, and secondary supplier site 208a-208n may, in at least one embodiment, collectively comprise the supplier system 104 depicted therein.

Hence, it may be understood the supply chain platform 302 of various embodiments of the present disclosure may be configured to communicate with the inventory management database 102 when a primary supplier site 204 is experiencing a supply chain disruption event sufficient to generate constraint data 353. In so doing, the supply chain platform 302 may gather all relevant information, whether from the administrator system 110, the customer system 108, or otherwise, to identify and implement a response to such disruption event, such as the use of at least one secondary supplier site 208a-208n to assist the primary supplier site 204.

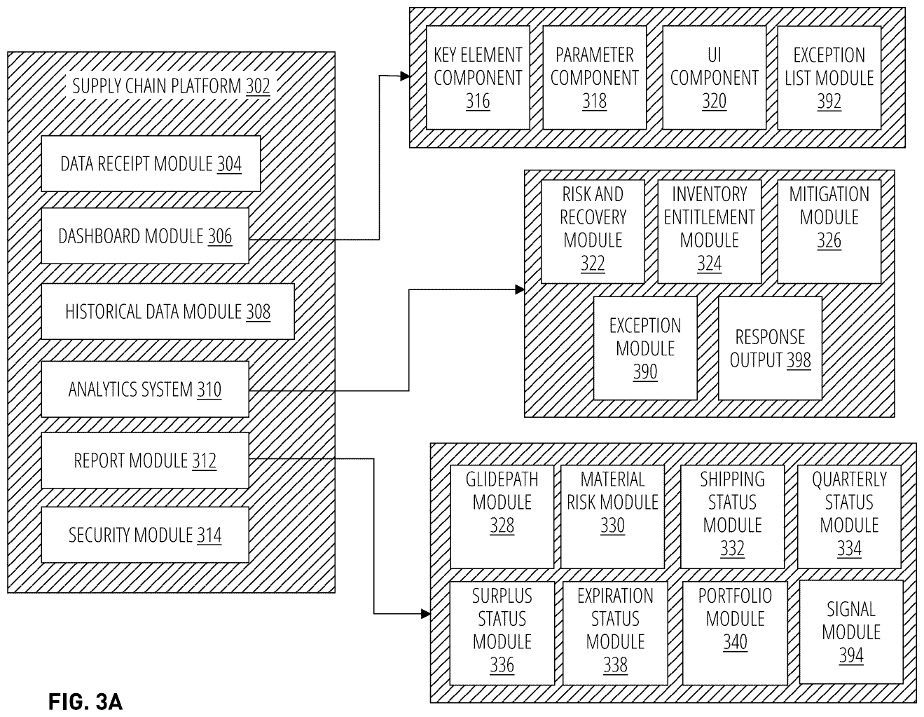

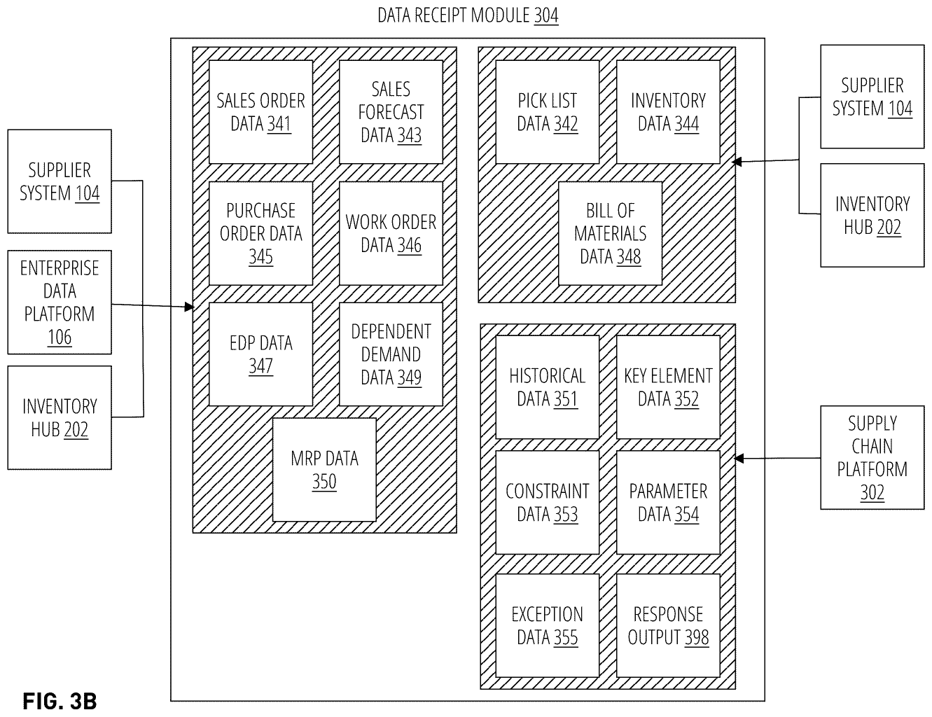

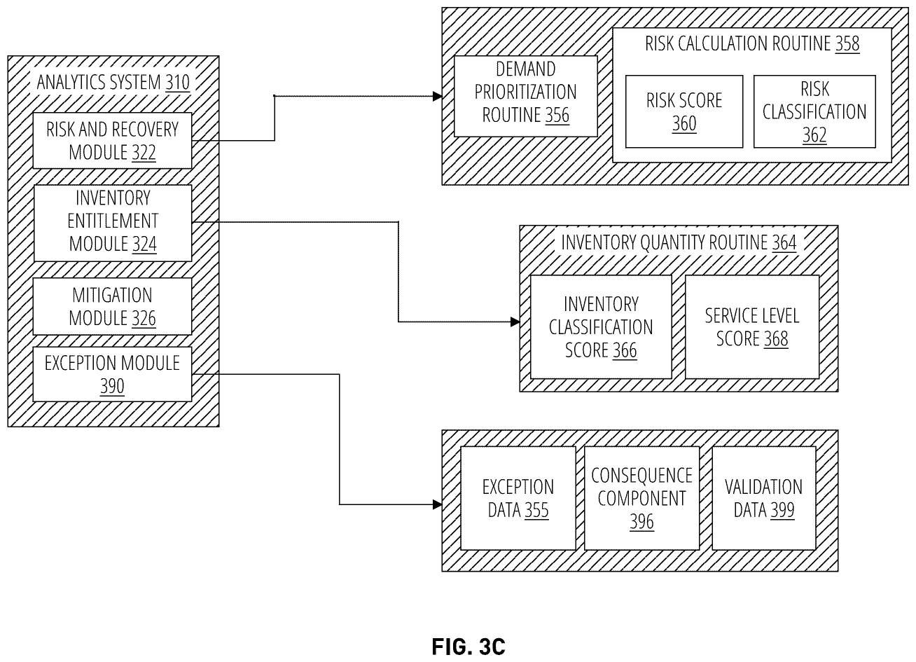

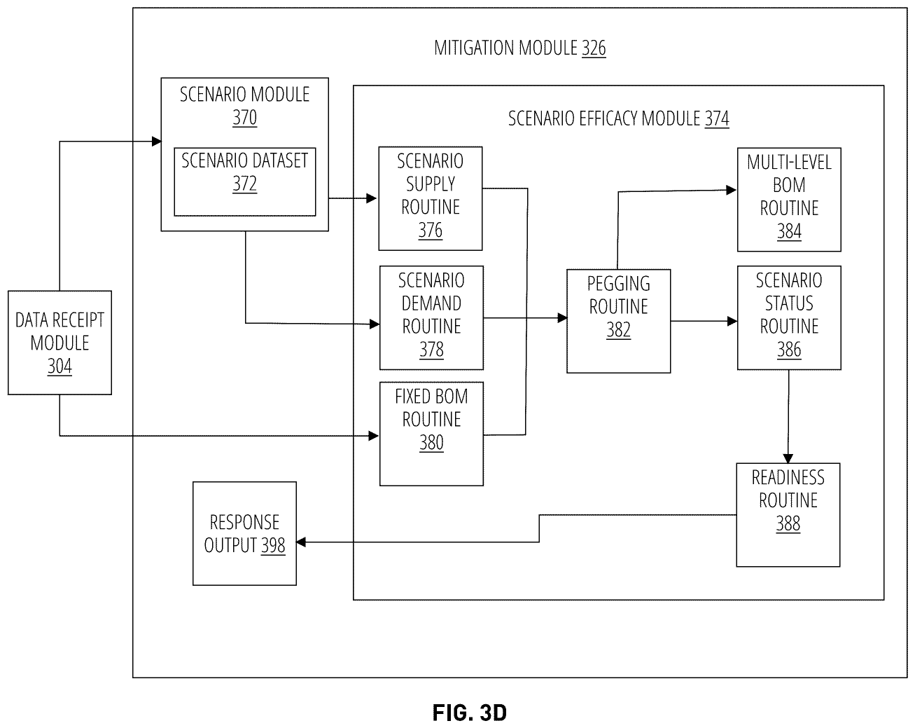

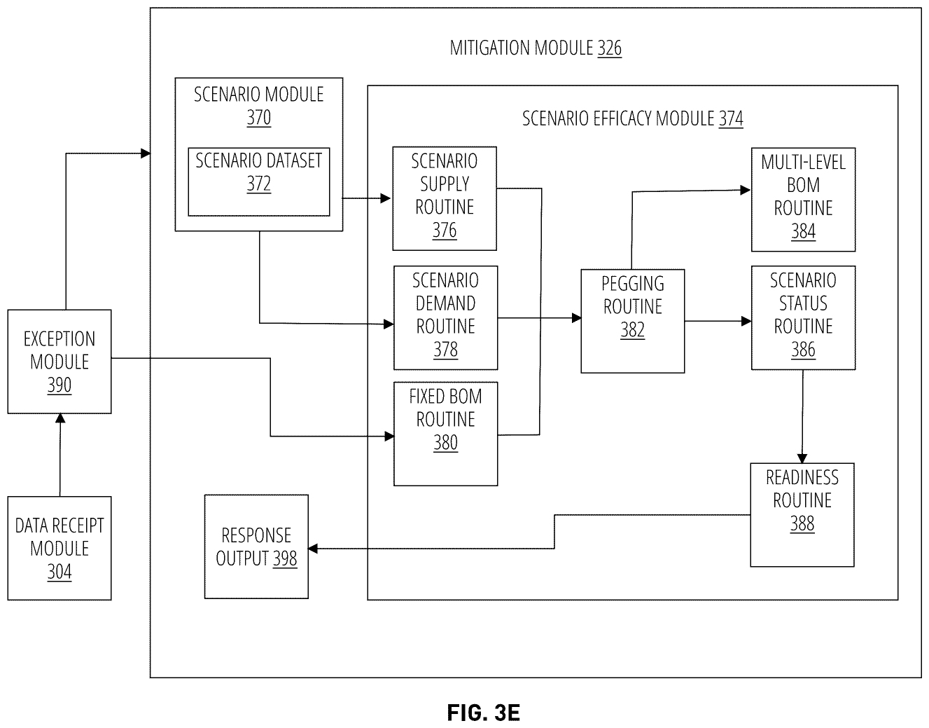

In view thereof, it may be understood the supply chain platform 302 may be configured to collect and transmit a variety of data, as well as perform a variety of functions relating to the logistical structure 200 of the organization. In at least one embodiment of the present invention, such as the one depicted in FIG. 3A, such a supply chain platform 302 may comprise certain modules and/or systems, such as: (a) a data receipt module 304; (b) a dashboard module 306; (c) a historical data module 308; (d) an analytics system 310; (e) a report module 312; and (f) a security module 314. Each of these modules and/or systems will be discussed in greater detail hereafter.

In at least one embodiment, such a data receipt module 304 may be configured to receive and store various portions of data from the various systems interconnected with the supply chain platform 302, such as the customer system 108, the administrator system 110, and the inventory management database 102 (and thus the supplier system 104 and the enterprise data platform 106 as well). For instance, as depicted in FIG. 3B, at least one embodiment of such a data receipt module 304 may be configured to collect a variety of data from the aforementioned systems and/or platforms, all of which may be collectively referred to herein as supply chain data. By way of example, sales order data 341, sales forecast data 343, purchase order data 345, work order data 346, EDP data 347 (electronic data processing data), dependent demand data 349, and MRP data 350 (material requirements planning data) may be collected from the enterprise data platform 106, inventory hub 202, and/or supplier system 104. Likewise, inventory data 344, pick list data 342, and bill of materials data 348 may be collected from the supplier system 104 and/or inventory hub 202. Historical data 351, meanwhile, may be collected from the supply chain platform 302, and more particularly from the historical data module 308 thereof, as will be discussed in greater detail hereafter. Likewise, key element data 352 may be collected from the supply chain platform 302 after being supplied from the customer system 108 and/or administrator system 110. Moreover, in at least one embodiment, such key element data 352 may be automatically provided by the supply chain platform 302 according to a rules module, which may be configured to, for instance, automatically determine the key element data 352 according to at least one regulatory metric, such as any applicable laws, rules, and/or regulations. As may be understood, the foregoing types of data collected by the data receipt module 304 is merely exemplary, and various data may be collected from each of the systems and/or platforms interconnected with the supply chain platform 302 for their collection and storage within the data receipt module 304.

As may be understood, due to the collection of a variety of data from a variety of sources, it is possible the data receipt module 304 of at least one embodiment of the supply chain platform 302 may receive data in a variety of formats, thereby leading to unstructured, redundant, or otherwise unclean data. Accordingly, the data receipt module 304 may, in at least one embodiment, comprise a data normalization routine through which the data receipt module 304 may revise and/or reorganize the data it receives to achieve a standardized data format.

Returning to FIG. 3A, at least one embodiment of the supply chain platform 302 of the present invention may comprise a dashboard module 306. Such a dashboard module 306 may be configured in input/output communication with the user device(s) 114 operated by the administrator(s) of the administrator system 110, the customer(s) of the customer system 108, and/or the other general users of the supply chain platform 302. For instance, such a dashboard module 306 may comprise a UI component 320 configured to generate one or more user interfaces to be displayed on the user device 114 and, more particularly, the display component 122 and/or interface component 124 thereof. Such UI component 320, and the various user interfaces generated and displayed thereby, will be discussed in greater detail hereafter.

Such a dashboard module 306 may further comprise a key element component 316 and a parameter component 318, each of which may be configured to enable a user—e.g., an administrator, a customer, or otherwise—to specifically interact with the supply chain platform 302. For instance, the key element component 316 may be configured to enable a user to input key element data 352 into the supply chain platform 302, which may enable such user to specifically identify which elements of the supply chain, and/or the products, goods, and materials flowing therethrough, are most impactful to the supply chain and/or its ability to fulfill any given purchase order. Conversely, such a parameter component 318 may be configured to enable a user to apply various parameters to the information presented by the supply chain platform 302. For instance, such a parameter component 318 may allow the user to apply parameter data 354 to the relevant information via at least one parameter input. Such parameter data 354 may include, without limitation, changes to the applicable date range, revenue basis, allowable lapse periods, risk hedging, and exemptions to types of risk mitigation strategies. Such key element component 316 and parameter component 318 will be discussed in greater detail hereafter.

With continued reference to FIG. 3A, it may be seen at least one embodiment of the supply chain platform 302 of the present invention may additionally comprise a historical data module 308. Such a historical data module 308 may be configured to generate historical data 351 which may be used by the supply chain platform 302 in its analysis of disruption events, generation of mitigation opportunities, and display of various portions of information. Such historical data 351 generated by the historical data module 308 may comprise, for instance, the performance history of the primary supplier site 204, which may include how the same responded to other disruptive events and whether the supply chain itself experienced a delay as a result thereof. As such, it may be understood such historical data 351 may generally include how a primary supplier site 204 has previously interacted with the various secondary supplier site(s) 208a-208n and/or distribution spoke(s) 206a-206n. Notwithstanding, alternative types, categories, and uses of historical data 351 are envisioned herein, such as any and all data and types thereof collected by the data receipt module 304.

At least one embodiment of the supply chain platform 302 of the present invention, such as the one depicted in FIG. 3A, may additionally comprise an analytics system 310. Such an analytics system 310 may be configured to generally ingest the data collected by the data receipt module 304 and analyze the same to determine a variety of relevant outputs. For instance, such an analytics system 310 may determine response output(s) 398 including, without limitation, risk and recovery to future demand, prioritization to demand, inventory entitlement, risk mitigation opportunities, excess and obsolete predictions and actions relating thereto, glidepaths, and quarterly status updates. As may be understood, the foregoing response outputs 398 are merely exemplary, and additional outputs are contemplated herein.

In at least one embodiment, such an analytics system 310 may comprise a risk and recovery module 322 and an inventory entitlement module 324, such as in the embodiment depicted in FIG. 3C. Such a risk and recovery module 322 may be configured to identify potential risks to a supply chain and assess the impact of such a risk. For instance, such a risk and recovery module 322 may comprise a risk calculation routine 358 which may, upon receiving data related to a potential disturbance to a supply chain, perform an analysis to generate a risk score 360, which itself may provide a metric indicating the risk of a delay somewhere along the supply chain. As may be understood, such a risk score 360 may, in at least one embodiment, consider the risks for specific distribution spokes 206a-206n, as well as for the primary supplier site 204 itself. For instance, with consideration of the supply chain of the logistical structure 200 depicted in FIG. 2, the constraint data 353 may flow into the risk and recovery module 322 and, in accordance with the data received by the data receipt module 304, the risk calculation routine 358 may generate a risk score 360 indicating whether any sales order data 341 residing at one or more of the distribution spokes 206a-206n is at risk of delay dependent, at least in part, on the historical data 351 relating to the primary supplier site 204. Such a risk calculation routine 358 may utilize a variety of indicators based on the data residing within the data receipt module 304 to determine the risk score 360, such as the inventory data 344, sales forecast data 343, and dependent demand data 349 indicating whether this particular disturbance may effect later sales, or bill of materials data 348, to assess whether this disturbance may impact other products contemplated in sales order data 341, and pick list data 342 to assess whether alternative options exist for collecting items to fulfill the relevant orders. As may be understood, the above operations of the risk calculation routine 358 is merely illustrative, and alternative operations are contemplated herein.

In conjunction therewith, at least one embodiment of such a risk calculation routine 358 may further comprise a risk classification 362, which may provide some classification for the risk score 360 calculated thereby. For instance, such a risk classification 362 may be used to indicate whether a risk is manageable, whether it should be monitored and/or mitigated, or whether it requires immediate action. In at least one embodiment, such a risk classification 362 may be individually tailored to a given distribution spoke 206a-206n, or to a particular user, such as a customer within the customer system 108. Accordingly, such a risk classification 362 may consider any key element data 352 and/or parameter data 354 into the supply chain platform 302 by a user through the dashboard module 306 or otherwise generated by the supply chain platform 302.

Further, such a risk and recovery module 322 may additionally comprise a demand prioritization routine 356 which may be configured to determine which demands and/or orders should be prioritized in the face of a given disturbance. Accordingly, such a demand prioritization routine 356 may utilize various data to determine a demand priority metric indicating whether sales order data 341 should be fulfilled or accepted, or whether a later fulfillment is preferable, amongst other similar prioritization tactics. As with the risk classification 362, such a demand prioritization routine 356 may consider key element data 352 and/or parameter data 354 input into and/or generated by the supply chain platform 302, such as the user's intention to avoid any delays greater than a set period of time, in making its demand prioritization decisions.

With continued reference to FIG. 3C, it may be seen the at least one embodiment of such an inventory entitlement module 324 of the analytics system 310 may comprise an inventory quantity routine 364, which may be configured to determine an appropriate minimum amount of stock for the supplier system 104 to have on hand. In at least one embodiment of the present invention, such an inventory quantity routine 364 may comprise an inventory classification score 366, which may be used to determine the importance of a particular type of inventory. For example, an item found in the bill of materials data 348 of numerous products may be deemed more important than an item used in connection with only one product. Likewise, an item used in connection with only one product with a larger amount of sales order data 341 may be deemed more important than an item used in connection with many products each having sales forecast data 343 indicating minimal purchases over the next period of time. Further, such an inventory quantity routine 364 may additionally calculate a service level score 368, which may be configured to determine the importance a user—e.g., an administrator, customer, and/or supplier—may place on a given product, location, or customer. For instance, a user may input key element data 352 into the dashboard module 306 indicating more or less emphasis to be placed on on-time delivery, which may be used to adjust the minimum quantity of inventory the primary supplier site 204 and/or secondary supplier sites 208a-208n should keep in stock.

Various embodiments of such an analytics system 310 of the supply chain platform 302 may additionally comprise a mitigation module 326. Such a mitigation module 326 may be configured to determine one or mitigation opportunities in view of a disturbance event. For instance, as depicted in FIG. 3D, such a mitigation module 326 may receive relevant data from the data receipt module 304, which may flow through a scenario module 370 and a scenario efficacy module 374 to determine a relevant mitigation opportunity and an anticipated efficacy associated therewith. Specifically, such a scenario module 370 may be configured to generate one or more scenarios and scenario dataset 372 associated therewith.

For instance, such a scenario module may determine a first scenario in which no mitigations are made according to only that data relating to firm demand and firm supply of the primary supplier site 204, such as EDP data 347, sales order data 341, pick list data 342, bill of materials data 348, sales forecast data 343, inventory data 344, purchase order data 345, and work order data 346. A second scenario may be determined according to the same information considered in the first scenario, except as applied from an expanded geographic perspective. A third scenario may instead append data relating to plan demand and plan supply—e.g., dependent demand data 349 and MRP data 350—to generate a scenario in which external non-firm supply is used as a mitigation opportunity. A fourth scenario may additionally append the availability of safety stock onto the third scenario as yet another mitigation opportunity. As previously stated, each such generated scenario may carry with it a scenario dataset 372 detailing the specifics of the scenario, such as the number of supply needed for the mitigation opportunity, timeframes for delivery, etc. As may be understood, the foregoing scenarios are merely exemplary, and other mitigation opportunities borne out of scenarios generated by the scenario module 370 are envisioned herein. Likewise, one or more of said scenario datasets 372 may include the use of one or more secondary supplier sites 208a-208n.

Using the scenario dataset(s) 372, at least one embodiment of a scenario efficacy module 374 may be configured to employ one or more routines to determine whether a given scenario is anticipated to be effective in responding to a given disturbance event. For instance, a scenario supply routine 376 and a scenario demand routine 378 may be collectively employed to determine the degree to which supply and demand may be affected by the proposed scenario. Meanwhile a fixed BOM routine 380 may be utilized to collect bills of materials data 348 related to the scenario at issue from the data receipt module 304. Collectively, the outputs from the scenario supply routine 376, scenario demand routine 378, and fixed BOM routine 380 may be fed into a pegging routine 382 configured to specifically link specific items of inventory data 344 with specific sales order data 341, purchase order data 345, and/or work order data 346 according to the supply, demand, and bill of materials data 348 generated from the foregoing routines. Subsequent thereto, a multi-level BOM routine 384 may be employed to generate a multi-level bill of materials. And, finally, a scenario status routine 386 may be used to determine an efficacy metric indicating the degree of efficacy a given scenario may have as a mitigation opportunity, whereas a readiness routine 388 may be employed to determine a deployment metric indicating whether the given scenario is ready for immediate deployment or some deployment in the future—e.g., this situation will be ready in three days when a given secondary supplier site 208b will have a surplus of inventory available after receiving a new shipment of raw materials. In at least one embodiment, such a scenario efficacy module 374 may additionally comprise an ID matching routine configured to identify and/or confirm items from inventory data 344 match within those contemplated in the given scenario. In at least one embodiment, such a scenario efficacy module 374 may generate a response output 398 in accordance with the foregoing.

Accordingly, the risk and recovery module 322, inventory entitlement module 324, and mitigation module 326 of at least one embodiment of the analytics system 310 may collectively predict the risk associated with a given disturbance event, proactively prioritize which sales order data 341 should be fulfilled in view of such a disturbance, organically calculate and adjust minimum inventory quantities through fluctuations caused by one or more disturbance events, and identify potential mitigation opportunities and the anticipated efficacy associated therewith. In so doing, at least one embodiment of the analytics system 310 may develop an end-to-end solution to a disturbance event, taking into consideration the various needs of each section of the supply chain and providing visibility to the various users thereof.

In at least one embodiment of the present disclosure, such as the ones depicted in FIGS. 3A, 3C, and 3E, such an analytics system 310 may additionally comprise an exception module 390. Such an exception module may be configured to automatically determine exception data 355 related to the disturbance event(s) generating constraint data 353 at a primary supplier site 204. Such exception data 355 may comprise, for instance, a list of disturbance event(s) which may be ignored and/or deprioritized in relation to the response and decision-making processes of the supply chain platform 302.

In at least one embodiment, such exception data 355 may be generated according to a consequence component 396 configured to determine appropriate exception data 355 in view of the data collected by the data receipt module 304. For instance, such a consequence component 396 may be configured to assess the constraint data 353 in relation to historical data 351 associated disruption events previously responded to through the supply chain platform 302 described herein. For instance, such a consequence component 396 may utilize the constraint data 353 of the present disruption event to identify comparable constraint data 353 from a prior disruption event—i.e., a disruption event previously received and/or addressed by the supply chain platform 302. Subsequent thereto, such consequence component 396 may compare response output(s) 398 associated with such prior disruption event to determine an exception likelihood—i.e., the likelihood the disruption event associated with the present constraint data 353 should be classified as an exception and thereby be identified as exception data 355. As may be understood, such exception data 355 may be continuously adjusted as historical data 351 is generated by the supply chain platform 302, wherein certain types of disruption events identified within the constraint data 353 may be added and/or removed from such exception data 355.

In so doing, it may be understood the exception module 390 may be configured to differentiate between types of disruption events, such as by identifying important disruption events from insignificant disruption events. For instance, for one organization, a present disruption event—i.e., a disruption event presently at issue—at a primary supplier site 204 relating to a commonly produced article may be of little consequence—e.g., corrugated boxes may be common and manufactured at numerous secondary supplier sites 208a-208n, and thus identifying an appropriate secondary supplier site 208a for remedial action may be considered an easy fix. In the same vein, such an exception module 390 may identify important disruption events such as those associated with rarer articles or those articles for which a delay will cause greater disruptions throughout the logistical structure 200. And, similarly, such exception module 390 may identify, according to the historical data 351, whether a disruption event previously identified as exception data 355 should be removed therefrom—e.g., although corrugated boxes are common, persistent issues at a primary supplier site 204 have exhausted overflow stock at the nearby secondary supplier sites 208a-208n, and thus remediation of the present constraint data 353 will not be a routine matter.

In view thereof, the exception module 390 of various embodiments of the present disclosure may comprise one or more machine learning models configured to perform the aforementioned functions. Such machine learning models may include, without limitation, regression models, linear regression models, classification models, tree-based models, clustering models, or some combination thereof. As may be understood, the identification of the appropriate machine learning model(s) for the exception module 390 may, in certain embodiments, depend on the data collected by the data receipt module 304, the historical data 351, the logistical structure 200 of the organization, and, more generally, the structure of the supply chain system 100 itself. Hence, in at least one embodiment, such machine learning model(s) for use by the exception module 390 may be determined according to Monte Carlo simulations and/or other similar such methodologies.

In at least one embodiment, the exception data 355 generated by the consequence component 396 may be be validated by a user, such as through an exception list module 392 of the dashboard module 306. Such an exception list module 392 may be configured to display the current exception data 355, and relevant information associated therewith such as the relevant constraint data 353 associated with the determination thereof, to a user for validation. In so doing, a user may manually determine validation data 399 associated with the exception data 355, which may be stored as historical data 351 for future use by the consequence component 396. Alternatively, such validation data 399 may instead be determined according to the consequence component 396 itself, such as by referencing historical data 351 associated with exception data 355, such as the results of actions taken, or the lack thereof, both before and after a disruption event was identified as exception data 355.

With reference now to FIG. 3E, it may be seen the exception module 390 may, in at least one embodiment, be utilized in connection with the mitigation module 326. For instance, any data to be transmitted to the mitigation module 326 from the data receipt module 304 may first flow through such exception module 390. In so doing, the exception module 390 may first filter out constraint data 353 for which no mitigation is imminently necessary. In so doing, the analytics system 310 may thus prioritize analyses for the most important disruption events.

Returning now to FIG. 3A, it may be seen at least one embodiment of the supply chain platform 302 of the present invention may comprise a report module 312. Such a report module 312 may be configured to generate one or more reports which may be displayed to a user operating a user device 114 through the UI component 320 of the dashboard module 306. In at least one embodiment, such a report module 312 may be interactive such that the various report(s) generated thereby may be modified in real-time, such as through the key element component 316 and/or parameter component 318 of the dashboard module 306. As may be understood, the various modules of which the report module 312 is comprised may each be configured to generate a different interactive report for a user. For instance, a glidepath module 328 may be configured to generate outputs relating to a glidepath report depicting risk and clearance projections, such as the material risk in view of a disruption event as well as the degree to which a predicted backorder may affect revenue expectation over a period of time.

A material risk module 330, meanwhile may depict a variety of metrics relating to the material risk associated with a supply chain in the face of a disturbance event, such as the quantity of inventory at risk, the revenue loss associated therewith, and the degree to which production may be delayed over a period of time. In at least one embodiment, such a material risk module 330 may generate one or more interactive data visualization(s) 404, such as an interactive heat map, depicting, for instance, the top mitigable risks. In so doing, such an interactive data visualization 404 may depict which products, goods, items, and/or materials are both at risk due to one or more disturbance events and remediable via one or more mitigation opportunities. However, it may be understood such an interactive data visualization 404, whether comprising an interactive heat map or otherwise, may instead depict alternative portions of relevant data, such as the least mitigable risks.

In various embodiments of the present invention, such an interactive data visualization 404 may be configured for interaction by one or more users to enable a dynamic sensitivity analysis thereby. For instance, the parameter component 318 may be utilized to adjust the risk tolerance used by the analytics system 310, adjust the allowable lapse period and/or allowable delay period, enable risk hedging, and/or enable varying degrees of risk exemptions. Accordingly, user(s) of the supply chain platform 302 may be enabled to adjust the sensitivity of the analytics system 310, such as by specifying the type of risk to be considered, the type of mitigation opportunities falling within a prescribed timeframe, and the acceptable degree of risk tolerance for any primary supplier site 204, secondary supplier site 208a-208n, and/or distribution spoke 206a-206n. As may be understood, such variety of adjustable parameterizations adjustable by the user(s) for such dynamic sensitivity analysis is merely exemplary, and alternative types of parameterizations and/or degrees thereof are envisioned herein. Likewise, it should be understood the foregoing dynamic sensitivity analysis may be applied to one or more reports and/or displays generated by the report module 312, such that, in at least one embodiment of the present invention, the user selections afforded by the parameter component 318 and/or key element component 316 may permeate throughout the report module 312.

Yet additional outputs of various embodiments of the report module 312 may comprise a shipping status module 332, a quarterly status module 334, a surplus status module 336, an expiration status module 338, and a portfolio module 340. Such a shipping status module 332 may be configured to output data relating to, for instance, products that are built but yet to ship, along with commentary detailing any order lag associated with such shipment. Such a quarterly status module 334 may be configured to output data relating to the degree of concordance between an expected execution and an actual execution of the supply chain itself, or various portions thereof. The surplus status module 336 may be configured to output data relating to an surplus inventory, including a description of the inventory, an applicable stock keeping unit number, the inventory's location, and the amount of surplus, thereby enabling shorter lead times for customers and the ability to easily visualize potential business opportunities. Likewise, such an expiration status module 338 may be configured to output data relating to materials set to expire or otherwise having a do not sell after designation including, without limitation, data relating to the value of such materials, the timeframes for expiration, and fillable fields for user-input comments and/or designations. Such a portfolio module 340, meanwhile, may generally output data relating to a portfolio of goods, products, materials, and/or inventory, including, for instance, a forward-looking view at risk and stock health as well as a support strategy for supply maintenance. As may be understood, such outputs of the various embodiments of the report module 312 are not exhaustive as additional outputs and accompanying modules are envisioned herein. Moreover, it may be understood the various modules and/or functions employed by the analytics system 310, such as the risk and recovery module 322, the inventory entitlement module 324, and/or the mitigation module 326 may be applied and/or depicted within any such output of the report module 312. Likewise, exception data 355 associated with the exception module 390 may be configured for application and/or display through the various embodiments of the report module.

With continued reference to FIG. 3A, at least one embodiment of such a supply chain platform 302 may comprise a security module 314. Such a security module 314 may be configured to provide secure transmission of data between the various systems and/or platforms interconnected with the supply chain platform 302. Likewise, such a security module 314 may be configured to provide identity verification procedures for the user(s) operating the user device(s) 114, such as suppliers, customers, and/or administrators.

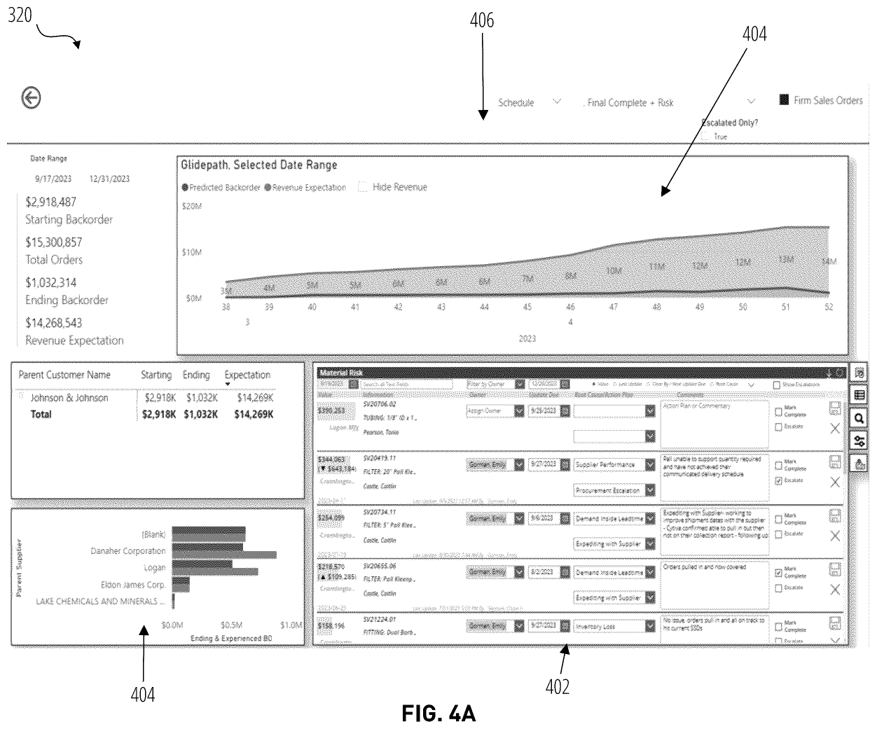

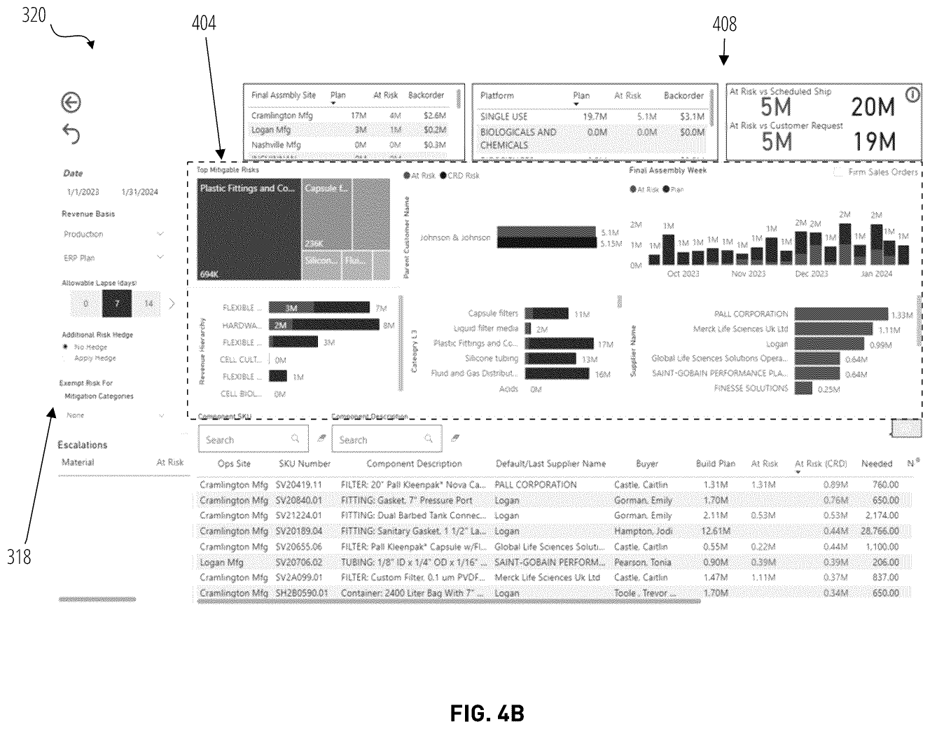

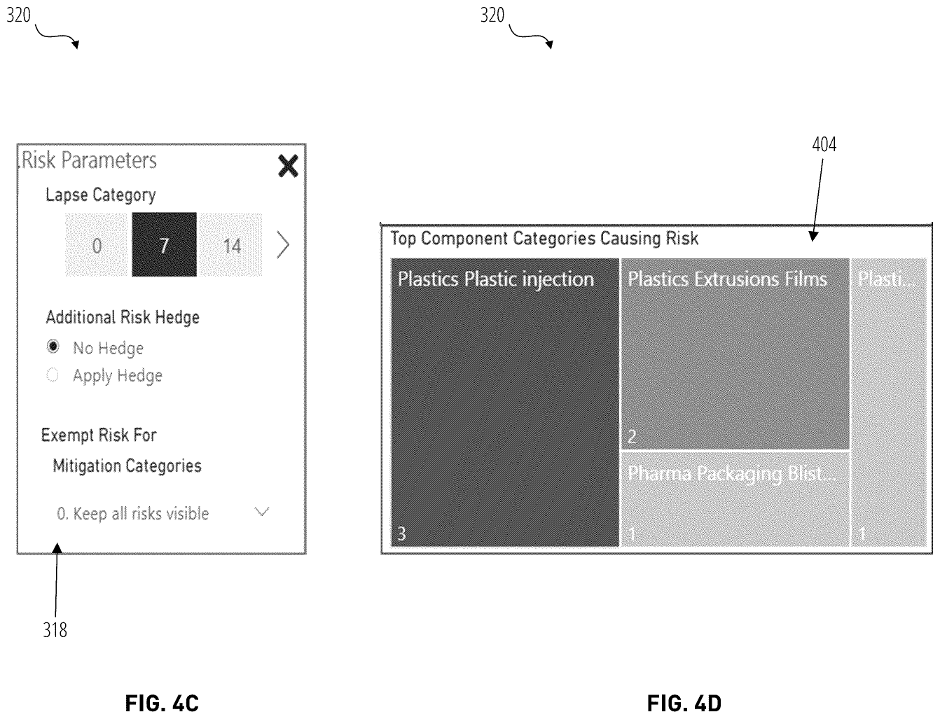

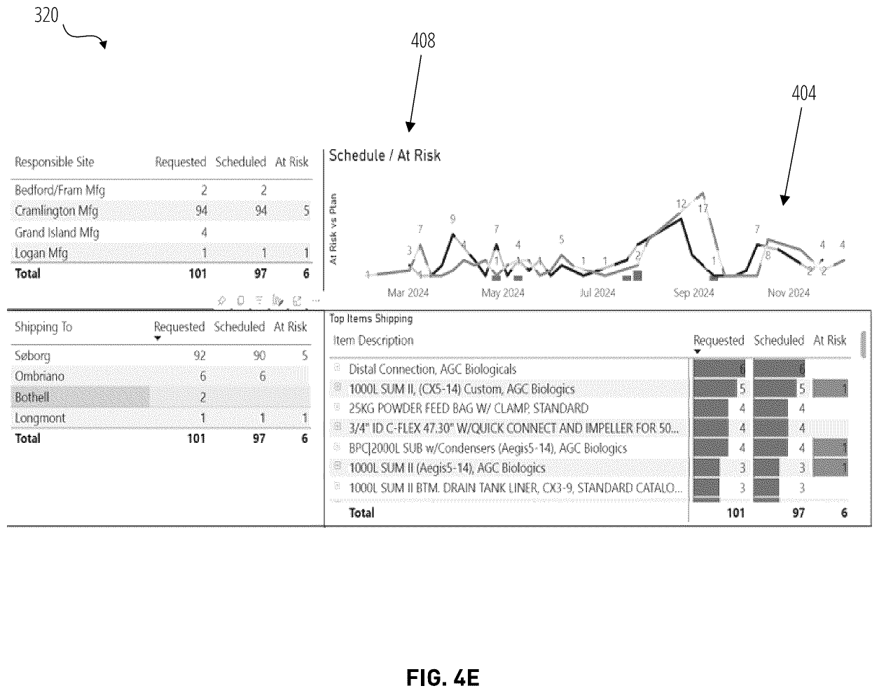

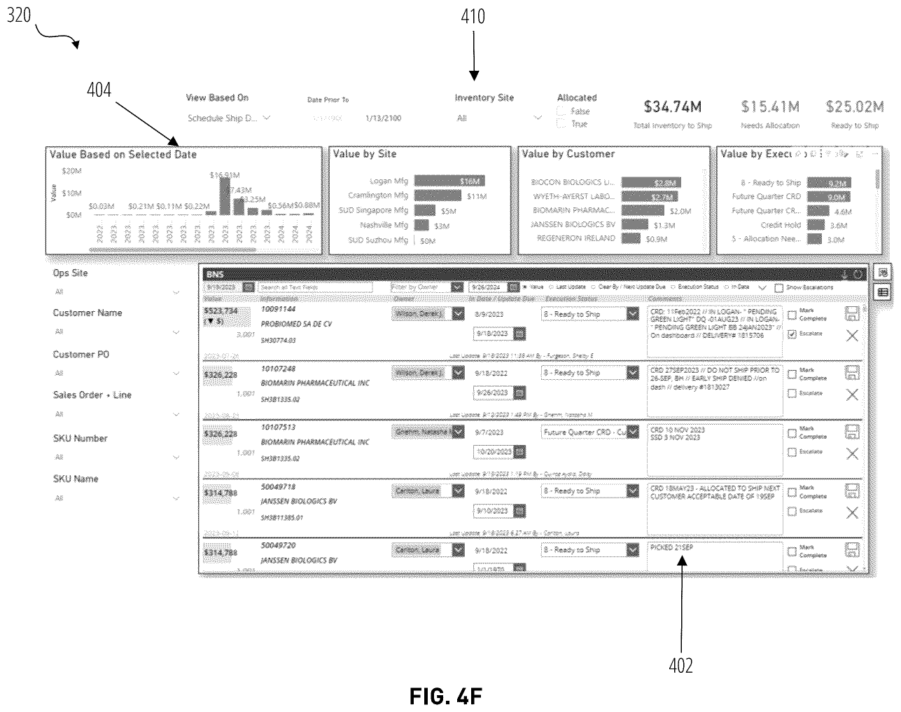

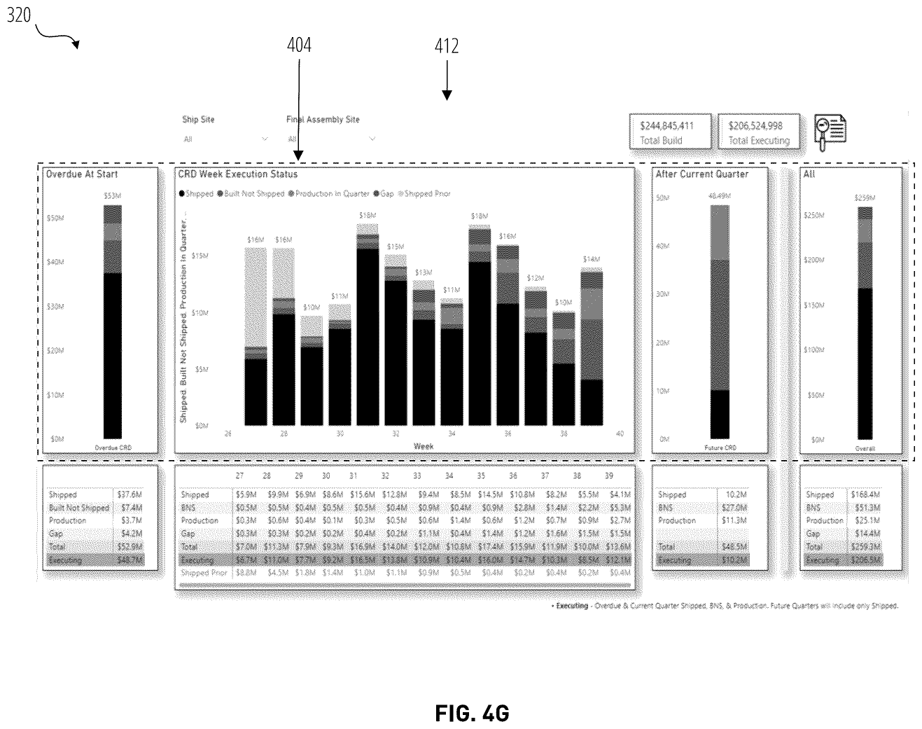

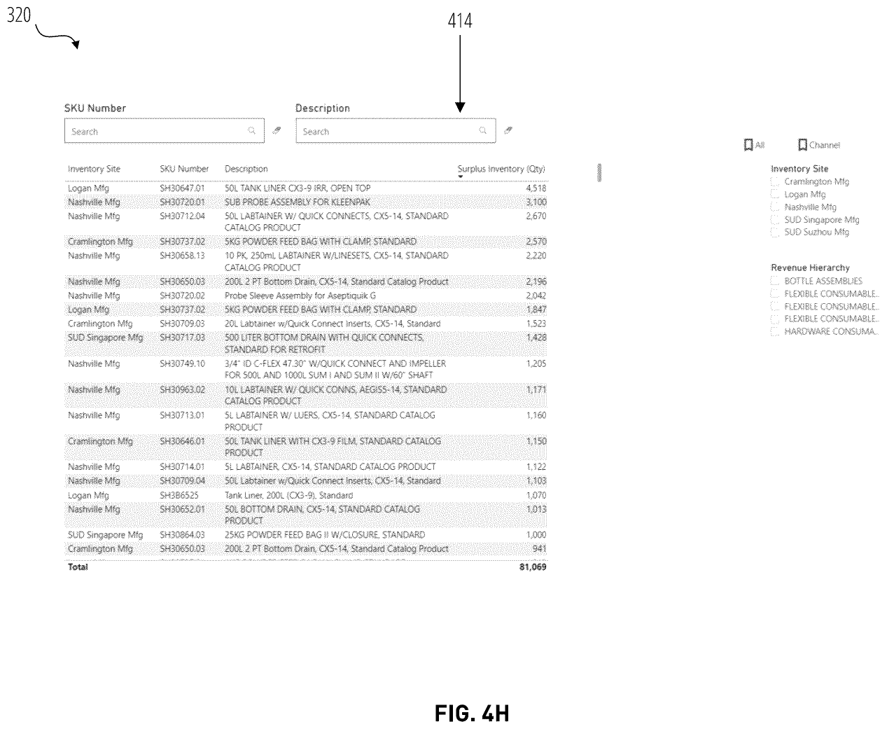

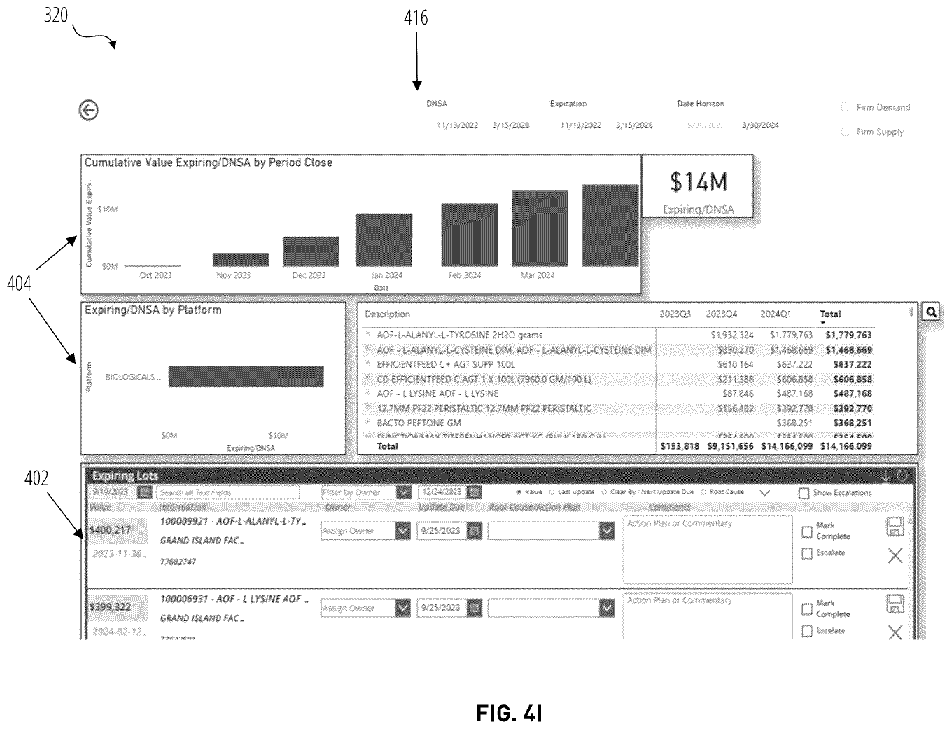

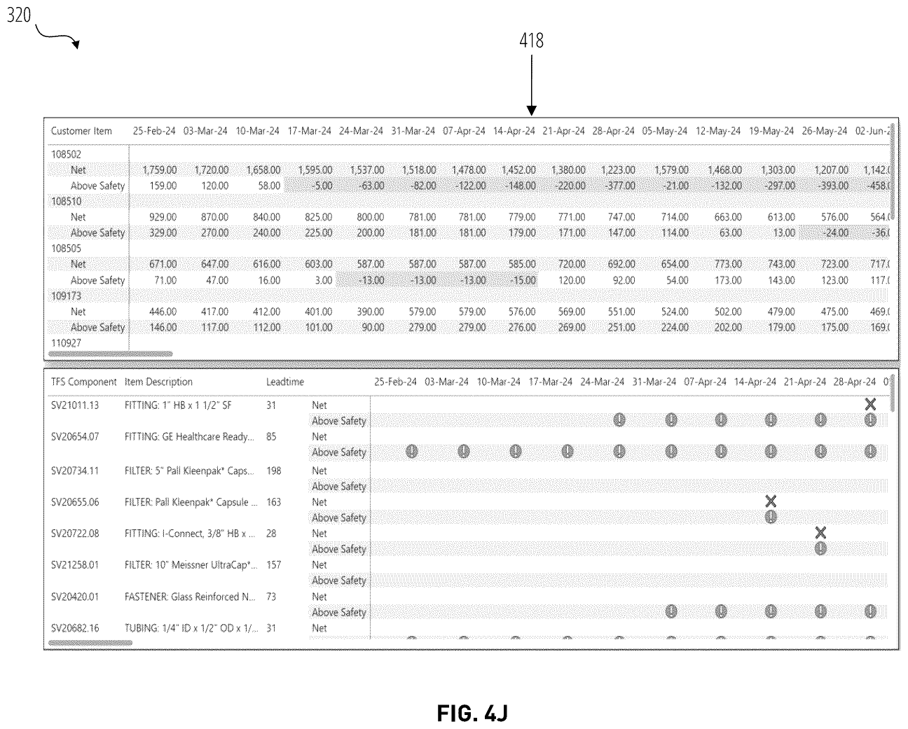

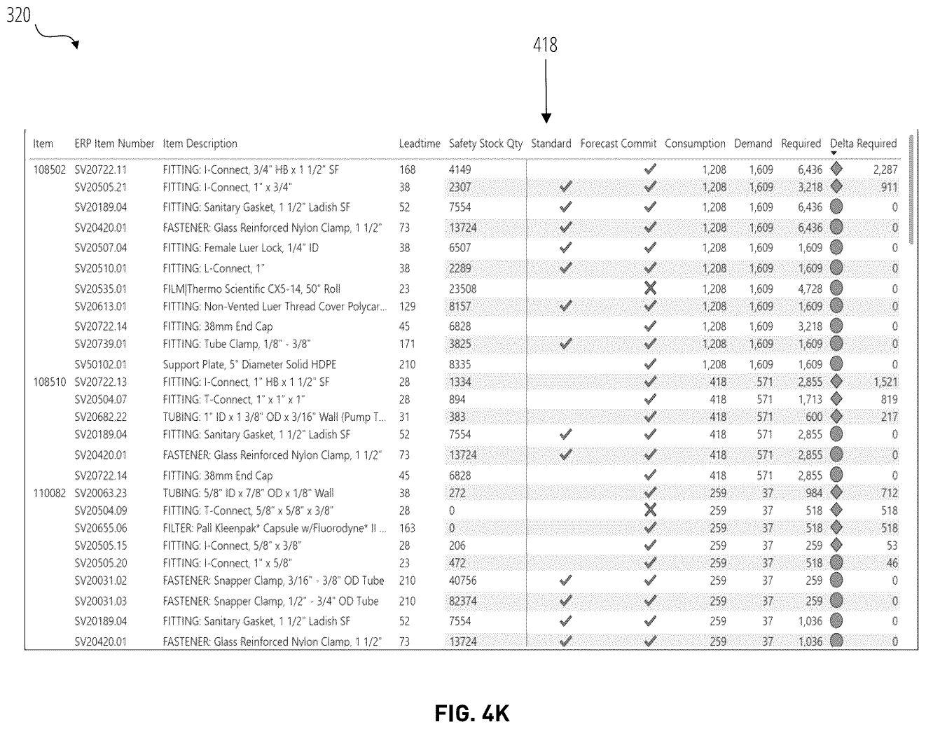

FIGS. 4A-4K generally depict various outputs of such report module 312 as generated, displayed, and/or provided to the user(s) through the UI component 320 of the dashboard module 306 for display on the user device(s) 114 and, particularly the display component 122 thereof. As may be understood, the user interface outputs depicted in such Figures is merely exemplary, as are the data, interactive data visualizations 404, and other windows, buttons, fields, and other user interface elements depicted thereon.

With reference specifically to FIG. 4A, it may be seen such UI component 320 is depicting at least one embodiment of an output of the glidepath module 328, which may comprise a glidepath report 406. As may be seen, such output may include an interactive data visualization 404 depicting, for instance, a line graph of a glidepath for a selected date range, and a bar chart for suppliers. Such output may further include a user input window 402 comprising a plurality of data fields, buttons, and other user interface elements through which a user may make selections, input comments, and indicate the status of a given piece of data relating to material risk.

FIGS. 4B and 4E likewise depict at least one embodiment of an output of a material risk module 330, which may comprise a material risk report 408. Such an output may include at least one interactive data visualization 404, including an interactive heat map depicting top mitigable risks, as well as a variety of bar charts depicting various other portions of data. Likewise, as shown in FIG. 4E, such an interactive data visualization 404 may, in at least one embodiment, additionally include a line graph having user selectable elements disposed thereon. In at least one embodiment, such user selectable elements may be configured to display additional data upon selection thereof. Such an output may, in at least one embodiment, further include a user interface representation of a parameter component 318, through which a user may selectively apply parameter data 354, as discussed in greater detail heretofore. Such embodiments of the user interface representation of the parameter component 318 and an interactive data visualization 404 are depicted in FIGS. 4C and 4D for further reference.

Depicted in FIGS. 4E-4I are various embodiments of the outputs of the shipping status module 332, quarterly status module 334, surplus status module 336, and expiration status module 338, respectively. FIGS. 4J and 4K, meanwhile, each depict at least embodiment of the portfolio module 340. As may be noted, each such output—e.g., a shipping status report 410, a quarterly status report 412, a surplus status report 414, an expiration status report 416, and a portfolio report 418—may include an interactive data visualization 404 and/or a user input window 402, each of which may function in accordance with the disclosure recited heretofore. As may be noted, each of such outputs may depict different portions of data, any one of which may stem from the various portions of the supply chain platform 302.

In view thereof, various embodiments of the supply chain system 100 disclosed herein are configured to increase the efficiency and adaptability of supply chains operated by vertically integrated organizations. Such supply chain system 100 may provide greater visibility across an organization, provide predictive analyses, and develop prescriptive plans in response to a disruptive event. Furthermore, such supply chain system 100 may provide insights between various segments of the organization and harmonize designs and strategies to facilitate site-to-site sharing. Such supply chain system 100 may further be user-configurable to enable specific parameterization of the analyses of outputs thereof. And, in various embodiments, such a supply chain system 100 may be configured to identify and differentiate between important and inconsequential disruptive events at primary supplier site(s) 204 to generate exception data 355, thereby enabling the supply chain platform 302 to assess, remediate, and display information most useful to a user.

What is claimed is:

1. A supply chain system comprising:
an inventory management hub communicatively configured in connection with a supply chain platform;
said supply chain platform communicatively configured in connection with at least one customer system and at least one user device;
said supply chain platform comprising a supply chain server system configured to perform at least one process of said supply chain platform;
said supply chain platform further comprising:
a data receipt module configured to receive said supply chain data from said inventory management hub;
an analytics system configured to determine at least one risk score according to a risk calculation routine performed on said supply chain data;
said analytics system further configured to generate at least one mitigation opportunity according to a mitigation module; and
a report module configured to generate at least one interactive data visualization for display on said at least one user device, said at least one interactive data visualization based on said at least one risk score and said at least one mitigation opportunity.

2. The supply chain management system of claim 1, wherein said supply chain data comprises sales order data, pick list data, sales forecast data, inventory data, purchase order data, work order data, EDP data, bill of materials data, dependent demand data, and MRP data.

3. The supply chain management system of claim 1, wherein said supply chain platform further comprises a historical data module configured to generate historical data.

4. The supply chain management system of claim 1, wherein said supply chain platform further comprises a dashboard module.

5. The supply chain management system of claim 4, wherein said dashboard module comprises a key element component configured to receive key element data from said at least one user device.

6. The supply chain management system of claim 4, wherein said dashboard module comprises a parameter component configured to receive parameter data from said at least one user device, said parameter data configured to apply at least one parameterization to said at least one interactive data visualization.

7. The supply chain management system of claim 1, wherein said analytics system is further configured to generate exception data through an exception module, said exception data determined according to said historical data.

8. The supply chain management system of claim 7, wherein said exception module comprises at least one machine learning model configured to determine said exception data by comparing first constraint data for a present disruption event at a primary supplier site with said historical data, said historical data comprising second constraint data and at least one response output from a prior disruption event, said at least one response output generated by said analytics system in relation to said prior disruption event.

9. A supply chain management system comprising:
an inventory management hub communicatively configured in connection with a supply chain platform;
said supply chain platform communicatively configured in connection with at least one customer system and at least one user device;
said supply chain platform comprising a supply chain server system configured to perform at least one process of said supply chain platform;
said supply chain platform further comprising:
a data receipt module configured to receive said supply chain data from said inventory management hub;
a historical data module configured to generate historical data;
an analytics system comprising a risk and recovery module configured to determine at least one risk score according to a risk calculation routine performed on said supply chain data and said historical data;
said analytics system further comprising a mitigation module configured to generate at least one mitigation opportunity according to said supply chain data and said historical data; and
a report module configured to generate at least one interactive data visualization for display on said at least one user device, said at least one interactive data visualization based on said at least one risk score and said at least one mitigation opportunity.

10. The supply chain management system of claim 1, wherein said supply chain platform further comprises a dashboard module, said dashboard module comprising:
a key element component configured to receive key element data from said at least one user device; and
a parameter component configured to receive at least one parameter input from said at least one user device.

11. The supply chain management system of claim 10, wherein said risk and recovery module is further configured to generate at least one risk classification according to at least said key element data.

12. The supply chain management system of claim 10, wherein said at least one interactive data visualization is configured for parameterization according to said at least one parameter input.

13. The supply chain management system of claim 9, wherein said mitigation module comprises a scenario module configured to generate at least one scenario dataset.

14. The supply chain management system of claim 13, wherein said mitigation module further comprises a scenario efficacy module configured to determine to at least one efficacy metric and at least one deployment metric for said at least one scenario dataset.

15. A supply chain management system comprising:
an inventory management hub communicatively configured in connection with a supply chain platform and a supplier system for a logistical structure, said logistical structure comprising a primary supplier site and at least one secondary supplier site, said primary supplier site configured to generate constraint data in relation to a disruption event;
said supply chain platform communicatively configured in connection with at least one customer system and at least one user device;
said supply chain platform comprising a supply chain server system configured to perform at least one process of said supply chain platform;
said supply chain platform further comprising:
a data receipt module configured to receive said supply chain data from said inventory management hub and said constraint data from said primary supplier site;
a historical data module configured to generate historical data;
a dashboard module comprising a key element component configured to receive key element data from said at least one user device and a parameter component configured to receive parameter data from said at least one user device;
an analytics system comprising a risk and recovery module configured to determine, in response to said constraint data, at least one risk score and at least one risk classification according to a risk calculation routine performed on said supply chain data and said historical data;
said analytics system further comprising a mitigation module configured to generate at least one mitigation opportunity, said at least one mitigation opportunity generated according to a scenario module configured to determine at least one scenario dataset and a scenario efficacy module configured to determine an efficacy metric and a deployment metric for said at least one scenario dataset; and
a report module configured to generate at least one interactive data visualization for display on said at least one user device, said at least one interactive data visualization based on said at least one risk score and said at least one mitigation opportunity, and configurable according to said at least one parameter input.

16. The supply chain management system of claim 15, wherein said at least one mitigation opportunity includes the use of said at least one secondary supplier site.

17. The supply chain management system of claim 15, wherein said dashboard module further comprises a UI component configured to generate at least one user interface according to at least one output of said report module for display on said at least one user device.

18. The supply chain management system of claim 17, wherein said report module comprises:
a glidepath module configured to generate a glidepath report;
a material risk module configured to generate a material risk report;
a shipping status module configured to generate a shipping status report;
a quarterly status module configured to generate a quarterly status report;
a surplus status module configured to generate a surplus status report;
an expiration status module configured to generate an expiration status report; and
a portfolio module configured to generate a portfolio report.

19. The supply chain management system of claim 15, wherein said risk and recovery module further comprises a demand prioritization routine configured to determine a demand priority metric.

20. The supply chain management system of claim 15, wherein said analytics system further comprises an inventory entitlement module configured to determine an inventory classification score and a service level score according to an inventory quantity routine.
